(19) United States
(12) Patent Application Publication
(10) Pub. No.: US 2017/0066956 A1
(43) Pub. Date: Mar. 9, 2017

(54) ENDOTHERMIC CHEMICAL REACTION TO REMOVE HEAT

(71) Applicant: CHEMBIO SHELTER, INC., Allentown, PA (US)

(72) Inventor: Edward V. Roscioli, Easton, PA (US)

(21) Appl. No.: 14/845,800

(22) Filed: Sep. 4, 2015

(51) Int. Cl. C09K 5/18

(52) U.S. Cl. CPC C09K 5/18

(57) ABSTRACT

A cooling composition comprising at least two solid particulate powders that undergo an endothermic chemical reaction when mixed together. The composition is made up of chemicals in dry powder form, making it unnecessary to use any liquid to initiate the chemical reaction. The resulting mixture is useful for cooling surfaces, liquids and solids.

### BACKGROUND OF THE INVENTION

Field of the Invention

This invention relates generally to cooling agents or compositions that can be used to cool surfaces, liquids and solids when activated upon mixing together.

Description of the Background

The present invention relates to compositions which produce an endothermic chemical reaction when mixed together.

Compositions producing an endothermic effect and devices or containers that utilize such compositions are known in the prior art. Such compositions typically produce their endothermic effect by heat absorbing processes. Examples of such endothermic processes include: melting ice cubes, melting solid salts, evaporating liquid water, making an anhydrous salt from a hydrate and the dissolution of salts in water.

With respect to cold packs, heat-absorbing processes based upon the dissolution of various salts in water are commonly described. Here the selection of a particular material has primarily been based upon the magnitude of its positive enthalpy of solution (heat of solution) and its solubility in water or another solvent whereby the most effective compositions have the highest positive heat of solution and highest solubility.

With respect to the above, U.S. Pat. No. 1,894,775 disclosed the use of various sodium, potassium and ammonium salt solutions, including sodium acetate, ammonium nitrate and sodium thiosulfate mixed with water, to provide therapeutic cooling in 1933.

Subsequently many other patents have disclosed the use of additional compounds along with various wetting and gelling agents and co-solvents other than water to improve the cooling performance of endothermic processes when applied to cold packs.

As an example, U.S. Pat. No. 3,957,472 describes a chemical heat transfer unit that uses compounds selected from a group that includes ammonium sulfamate, potassium nitrate, ammonium bisulfate, ammonium bromide, ammonium bicarbonate, ammonium iodide, ammonium magnesium selenate, ammonium maganese sulfate, ammonium phosphate dibasic, ammonium potassium tartrate, ammonium salicylate, ammonium sulfate, ammonium sodium sulfate, ammonium thiocyonate, ammonium persulfate, potassium phosphate, potassium sulfate, potassium sodium tartrate, potassium thiocyanate, potassium iodide, potassium chloride, urea, afenil, sodium acetate, sodium citrate, sodium nitrate, sodium thiocyanate, sodium thiosulfate, citric acid, tartaric acid, ferric ammonium sulfate and thiourea.

In another example, U.S. Pat. No. 4,081,256 describes an endothermic composition and cold pack whereby urea, hydrated sodium acetate, potassium chloride, potassium nitrate, ammonium chloride, and guar gum are blended together to extend the cooling life of the cold pack. Actually, the life of the cold pack is directly proportional to the rate of heat absorption of the cold pack. In this respect, it does not make sense to rate cold packs on an amount of time, such as 15 minutes. If the rate of heat absorption is high, the cooling life of the cold pack will be lower. For any given amount of mass of the constituents, a certain amount of heat can be absorbed (for example, total BTU's absorbed).

In still other examples, U.S. Pat. No. 4,010,620 utilizes ammonium chloride and ammonium nitrate for maximum cooling effect; U.S. Pat. No. 6,233,945 describes an extended life cold pack that uses ammonium nitrate, ammonium sulfamate, ammonium nitrite, ammonium iodide, ammonium bromide, sodium chloride, sodium nitrate, sodium nitrite, sodium carbonate, sodium bicarbonate, potassium nitrate, potassium nitrite, urea, methylurea, and combinations thereof; U.S. Pat. No. 5,429,762 discloses a cooling agent consisting of one or more of a group comprised of disodium hydrogen phosphate, sodium dihydrogen phosphate, trisodium phosphate, sodium ammonium hydrogen phosphate, diammonium hydrogen phosphate, and hydrates thereof; and U.S. Pat. No. 4,010,620 describes a cooling system that utilizes sodium nitrate, ammonium nitrate, ammonium thiocyanate, potassium thiocyanate, and ammonium nitrate individually or in combination.

A review of the prior art reveals that, although a wide variety of chemical compositions have been disclosed, only a select few are preferred, based upon performance as a cooling agent. The most common being ammonium nitrate dissolved in water or a combination of ammonium nitrate and urea dissolved in water.

An endothermic process absorbs heat from the environment during the dissolution of the compound in water. The theoretical heat absorbed during the dissolution of a compound in water can be calculated. However, the actual heat absorbed is always less than the theoretical maximum, due to system losses, impurities in the chemicals, and the difficulty in achieving a completely saturated solution of the chemicals. In this case, the chemicals remain unreacted and are just dissolved into solution.

In contrast to these endothermic processes, the chemicals of this invention actually undergo an endothermic chemical reaction. In this case, the chemicals themselves are changed into different product chemicals.

The compounds predicted to be most useful as cooling agents, when dissolved in water, include urea (CO(NH₂)₂), potassium fluoride dihydrate (KF.2(H₂O), potassium chloride (KCl), potassium bromide (KBr), potassium iodide (KI), potassium nitrite (KNO₂), potassium nitrate (KNO₃), potassium thiosulfate pentahydrate (K₂S₂O₃.5H₂O), potassium cyanide (KCN), potassium cyanate (KCNO), potassium thiocyanide (KCNS), sodium perchlorite (NaClO₃), sodium perchlorate (NaClO₃), sodium perchlorite dihydrate (NaClO₂.H₂O), sodium bromide dihydrate (NaBr.2H₂O), sodium nitrite (NaNO₂), sodium nitrate (NaNO₃), sodium acetate trihydrate (NaC₂H₃O₂.3H₂O), sodium thiosulfate pentahydrate (Na₂S₂O₃.5H₂O), sodium cyanide dihydrate (NaCN.2H₂O), sodium cyanate (NaCNO), ammonium chloride (NH₄Cl), ammonium bromide (NH₄Br), ammonium iodide (NH₄I), ammonium iodate (NH₄IO₃), ammonium nitrite (NH₄NO₂), ammonium nitrate (NH₄NO₃), ammonium cyanide (NH₄CN), ammonium thiocyanide (NH₄CNS), silver nitrate (AgNO₃) and rubidium nitrate (RbNO₃).

Of this group, potassium nitrite, potassium nitrate, sodium perchlorite, sodium perchlorate, sodium perchlorite dihydrate, sodium nitrite, sodium nitrate, ammonium nitrite and ammonium nitrate are all strong oxidizing agents and thus are reactive and have a tendency to promote combustion or are unstable during storage. Urea is also described as being unstable when mixed or blended with a wide variety of other endothermic compounds including ammonium nitrate.

Blends of urea and other compounds that are described in the prior art as having synergistic coolant properties are rendered ineffective by a reduced shelf-life. Potassium nitrite, potassium nitrate, sodium nitrate, ammonium nitrite and ammonium nitrate are also capable of detonation and explosion, with ammonium nitrate having a particularly bad reputation as the explosive of choice for weapons of terror, even though it is one of the most effective cooling agents disclosed in the prior art. Mixtures of ammonium nitrate and urea are also commonly formulated together to make powerful commercial explosives.

For all of the above reasons, cooling agents and compositions described in the prior art have had limited commercial success with the possible exception of cold pack applications. The most effective commercialized cold pack applications, however, utilize ammonium nitrate or mixtures of ammonium nitrate and urea and are susceptible to increased regulation and subject to restrictions on use, and may not be available for use in consumer products in the future. In addition, these products use the dissolution of the chemicals in water to provide cooling. This requires the use of water in the process which adds both weight and volume to the system.

### SUMMARY OF THE INVENTION

It is a principal object of this invention to provide safe, cooling compositions comprising solid powder chemicals that undergo an effective endothermic chemical reaction when mixed together, such that the resulting mixture is useful for cooling surfaces, liquids, and solids.

It is an additional object of this invention to provide solid powder chemicals that undergo an effective endothermic chemical reaction when mixed together and do not require the addition of water to initiate the chemical reaction.

It is an additional object of this invention to provide solid powder chemicals that undergo an effective endothermic chemical reaction when mixed together that are more efficient on a heat absorbed per weight or heat absorbed per volume basis than the existing chemical and water mixtures currently available on the market.

Accordingly, there is provided according to the invention a cooling composition having at least two solid particulate powders that undergo an endothermic chemical reaction when mixed together. According to one embodiment, at least one of the chemicals is barium hydroxide octahydrate Ba(OH)2*8H2O(s). According to another embodiment, at least one of the chemicals is ammonium chloride NH4Cl. And according to a preferred embodiment, a first solid particulate power is selected from the group consisting of barium hydroxide Ba(OH)2 and barium hydroxide octahydrate Ba(OH)2*8H2O(s), and a second solid particulate powder is selected from the group consisting of ammonium thiocyanate NH4CNS and ammonium chloride NH4Cl.

According to another embodiment a first chemical is barium hydroxide octahydrate and a second chemical is ammonium thiocyanate. According to a preferred embodiment barium hydroxide octahydrate is present in an amount of 35% to 90% by weight, and ammonium thiocyanate is present in an amount of 10% to 65% by weight. According to a more preferred embodiment barium hydroxide octahydrate is present in an amount of 60% to 80% by weight, and ammonium thiocyanate is present in an amount of 20% to 40% by weight. According to a further preferred embodiment barium hydroxide octahydrate is present in an amount of 65% to 75% by weight, and ammonium thiocyanate is present in an amount of 2% to 35% by weight. And according to a most preferred embodiment barium hydroxide octahydrate is present in an amount of 67.45% by weight, and ammonium thiocyanate is present in an amount of 32.55% by weight.

According to another embodiment, one of the chemicals is barium hydroxide octahydrate and another of the chemicals is ammonium chloride. According to one aspect of this embodiment, barium hydroxide octahydrate is present in an amount of 45% to 95% by weight, and ammonium chloride is present in an amount of 5% to 55% by weight. According to another aspect of this embodiment, barium hydroxide octahydrate is present in an amount of 65% to 85% by weight, and ammonium chloride is present in an amount of 15% to 35% by weight. According to a further aspect of this embodiment, barium hydroxide octahydrate is present in an amount of 70% to 80% by weight, and ammonium chloride is present in an amount of 20% to 30% by weight. And according to a most preferred aspect of this embodiment, barium hydroxide octahydrate is present in an amount of 74.68% by weight, and ammonium chloride is present in an amount of 25.32% by weight.

### DETAILED DESCRIPTION

A preferred composition within the broad ranges set forth above, which exhibits an optimum combination of properties, consists of 67.45% by weight of barium hydroxide octahydrate (Ba(OH)₂*8H₂O(s)) and 32.55% by weight of ammonium thiocyanate (NH₄SCN(s)).

An additional preferred composition consists of 74.68% by weight of barium hydroxide octahydrate (Ba(OH)2.8H2O) and 25.32% by weight of ammonium chloride (NH₄Cl).

With regard to the first preferred composition of this invention, the balanced chemical equation is:

Ba(OH)₂*8H₂O(s)+2 NH₄SCN(s)+170 kilojoule−>Ba(SCN)₂(s)+10 H₂O(l)+2 NH₃(g)

That is, one mole of barium hydroxide octahydrate (solid) plus two moles of ammonium thiocyanate (solid) plus 170 kilojoules of heat goes to one mole barium thiocyanate (solid) plus ten moles of water (liquid) plus 2 moles of ammonia (gas).

Considering the following properties of barium hydroxide octahydrate and ammonium thiocyanate, one can calculate the heat absorbed on a kilojoule per unit of weight and a kilojoule per unit of volume basis.

| | Molecular Weight | Density |
|---|---|---|
| Chemical | (grams/mole) | (kg/cubic meter) |
| Ba(OH)₂*8H₂O(s) | 315.46 | 2180 |
| NH₄SCN(s) | 53.49 | 1305 |

Therefore, using the chemicals of the first preferred composition of this invention, the heat absorbed on a kilojoule per unit of weight basis is: 402.4 kilojoule/kg and on a kilojoule per unit of volume basis it is: 749,945 kilojoule/cubic meter.

The heat absorbed by the dissolution of ammonium nitrate in water is as follows:

On a kilojoule per unit of weight basis is: 192.55 kilojoule/kg of solution.

On a kilojoule per unit of volume basis it is: 99,775 kilojoule/cubic meter of solution.

Thus on a weight basis, the chemicals of the first preferred composition of this invention are 2.09 times more efficient than the dissolution of ammonium nitrate in water. On a volume basis, the chemicals of the first preferred composition of this invention are 7.516 times more efficient than the dissolution of ammonium nitrate in water.

It is thus apparent that the preferred compositions of the present invention accomplish the principal objectives set forth above. Various modifications may be made without departing from the spirit and scope of the invention.

1. A cooling composition comprising at least two solid particulate powders that undergo an endothermic chemical reaction when mixed together.

2. A composition according to claim 1 wherein a first solid particulate power is selected from the group consisting of barium hydroxide Ba(OH)2 and barium hydroxide octahydrate Ba(OH)2*8H2O(s), and a second solid particulate powder is selected from the group consisting of ammonium thiocyanate NH4CNS and ammonium chloride NH4Cl.

3. A composition according to claim 1 wherein at least one of the chemicals is barium hydroxide octahydrate Ba(OH)2*8H2O(s).

4. A composition according to claim 1 wherein at least one of the chemicals is ammonium thiocyanate NH4CNS.

5. A composition according to claim 1 wherein at least one of the chemicals is ammonium chloride NH4Cl.

6. A composition according to claim 1 wherein one of the chemicals is barium hydroxide octahydrate and another of the chemicals is ammonium thiocyanate.

7. A composition according to claim 1, comprising barium hydroxide octahydrate in an amount of 35% to 90% by weight and comprising ammonium thiocyanate in an amount of 10% to 65% by weight.

8. A composition according to claim 1, comprising barium hydroxide octahydrate in an amount of 60% to 80% by weight and comprising ammonium thiocyanate in an amount of 20% to 40% by weight.

9. A composition according to claim 1, comprising barium hydroxide octahydrate in an amount of 65% to 75% by weight and comprising ammonium thiocyanate in an amount of 2% to 35% by weight.

10. A composition according to claim 1 consisting of 67.45% by weight of barium hydroxide octahydrate and 32.55% by weight of ammonium thiocyanate.

11. A composition according to claim 1 wherein one of the chemicals is barium hydroxide octahydrate and another of the chemicals is ammonium chloride.

12. A composition according to claim 1, comprising barium hydroxide octahydrate in an amount of 45% to 95% by weight and comprising ammonium chloride in an amount of 5% to 55% by weight.

13. A composition according to claim 1, comprising barium hydroxide octahydrate in an amount of 65% to 85% by weight and comprising ammonium chloride in an amount of 15% to 35% by weight.

14. A composition according to claim 1, comprising barium hydroxide octahydrate in an amount of 70% to 80% by weight and comprising ammonium chloride in an amount of 20% to 30% by weight.

15. A composition according to claim 1 consisting of 74.68% by weight of barium hydroxide octahydrate and 25.32% by weight of ammonium chloride.
